(19) United States
(12) Patent Application Publication
(10) Pub. No.: US 2026/0123623 A1
(43) Pub. Date: May 7, 2026

(54) DEVICES AND METHODS FOR TRANSPORTING AN ORGAN FOR TRANSPLANTATION

(71) Applicant: Traferox Technologies Inc., Mississauga (CA)

(72) Inventors: Mathieu ALLARD, Mississauga (CA); Alexander SHVARTSBERG, Oakville (CA); Dwarakesh RAMESH, Mississauga (CA)

(73) Assignee: Traferox Technologies Inc., Mississauga (CA)

(21) Appl. No.: 19/374,829

(22) Filed: Oct. 30, 2025

Related U.S. Application Data
(60) Provisional application No. 63/715,170, filed on Nov. 1, 2024.

(51) Int. Cl. A01N 1/146; A01N 1/143

(52) U.S. Cl. CPC A01N 1/146; A01N 1/143

(57) ABSTRACT

An organ transportation apparatus is provided. The organ transportation apparatus comprises an insulating enclosure comprising a compartment, a lower receptacle positionable in the compartment configured to hold at least a first type of organ, and an upper receptacle positionable in the compartment above the at least one lower receptacle and configured to hold at least a second type of organ. The organ transportation apparatus is configured to transport different types of organs using different, removable receptacles.

### CROSS-REFERENCE TO RELATED APPLICATIONS

This application claims the benefit of U.S. Provisional Application No. 63/715,170, filed Nov. 1, 2024, the entire contents of which are incorporated herein by reference.

### FIELD

The present disclosure relates to organ preservation, and more particularly, to organ preservation prior to transplantation.

### BACKGROUND

Preserving a donor organ ex vivo requires very careful handling to ensure that the donor organ remains viable for transplantation. Without proper handling, the donor organ can become damaged beyond repair, ruining the chances for that organ to potentially save a life. For example, currently, only about one in four donor lungs are suitable for transplant, and approximately one in five people waiting for a donor lung dies before they can receive a donor lung.

Conventional methods for donor organ preservation include removing the organ from the donor and placing it on ice in a conventional cooler. The donor organ remains on ice until it may be ready to be transplanted into a recipient. Donor organs are often transported from the site of the donor to the site of the organ recipient. This often entails placing a donor organ on ice in a conventional transportable cooler. Such coolers may or may not include the ability to monitor and/or control the temperature of the donor organ, potentially allowing the organ to reach a temperature outside of an optimal range. Care must be taken that the donor organ is properly secured and supported by the transportable cooler to reduce risk of injury to the donor organ during transportation.

### SUMMARY

An apparatus for organ preservation includes a plurality of removable receptacles configured to stably house different types of organs within a cooled compartment for transportation. A user may place an organ contained within a sealed bag of preservation fluid within the particular receptacle that corresponds to the type of organ. The receptacle may be configured to contain and support the particular type of organ so that the organ does not experience excessive motion during transportation. The apparatus may be configured to accommodate receptacles for different types of organs at the same time so that the apparatus can be transported to a transplantation site with receptacles for different types of organs held within. By being able to receive multiple receptacles of different shapes and sizes for different organs, a singular apparatus can enable safer and more convenient transportation of donor organs of different kinds. The apparatus may further include a temperature sensor to monitor the temperature of a donor organ and/or the sealed bag within which the organ is placed.

In some embodiments, an organ transportation apparatus is provided, the organ transportation apparatus comprising an insulating enclosure comprising a compartment; a lower receptacle positionable in the compartment configured to hold at least a first type of organ; and an upper receptacle positionable in the compartment above the at least one lower receptacle and configured to hold at least a second type of organ.

In some embodiments, the compartment is configured to contain additional organ preservation fluid. In some embodiments, the compartment comprises at least one shelf configured to support the upper receptacle. In some embodiments, the upper receptacle comprises at least one flange configured to be positioned on the at least one shelf. In some embodiments, the compartment comprises at least one shelf configured to support the lower receptacle. In some embodiments, the at least one first type of organ comprises a lung and the at least one second type of organ comprises a heart. In some embodiments, the organ transportation apparatus further comprises a temperature sensor attached to the lower receptacle. In some embodiments, the upper receptacle comprises a slot configured to receive the temperature sensor. In some embodiments, the upper receptacle comprises a cylindrical portion. In some embodiments, the upper receptacle comprises a conical portion. In some embodiments, the upper receptacle comprises an upper portion having a first diameter and a lower portion having a second diameter, wherein the second diameter is smaller than the first diameter. In some embodiments, the lower receptacle and the upper receptacle comprise openings that enable airflow. In some embodiments, the lower receptacle comprises at least one recess for receiving at least one projection of the upper receptacle for providing stability to the upper receptacle. In some embodiments, the upper receptacle and the lower receptacle are removable. In some embodiments, the upper receptacle comprises at least one wall defining a chamber for supporting the second type of organ, the chamber sized to accommodate an entire second type of organ. In some embodiments, the lower receptacle comprises at least one wall defining a chamber that is sized to only partially accommodate the first type of organ within. In some embodiments, the at least one wall of the upper receptacle is spaced from a side wall of the compartment to accommodate one or more bags of organ preservation fluid. In some embodiments, the upper receptacle comprises a chamber having a first width and the lower receptacle comprises a chamber having a second width, wherein the second width is wider than the first width. In some embodiments, the upper receptacle comprises a chamber having a first height and the lower receptacle comprises a chamber having a second height, wherein the second height is shorter than the first height. In some embodiments, the organ transportation apparatus further comprises at least one cooling pack positioned within the compartment below the lower receptacle. In some embodiments, the lower receptacle is positioned above the at least one cooling pack and sits on the at least one lower shelf. In some embodiments, the wall has at least one shelf and the lower receptacle is positioned on the shelf such that the lower receptacle is spaced from the cooling packs. In some embodiments, the organ transportation apparatus further comprises at least one cooling pack positioned above the upper receptacle. In some embodiments, the upper receptacle is positioned below the at least one cooling pack and is supported by the at least one shelf. In some embodiments, a lid of the apparatus comprises a retainer configured to hold the at least one cooling pack positioned above the upper receptacle. In some embodiments, the retainer is configured to hold the upper receptacle in place.

In some embodiments, a method for transporting one or more organs for transplant is provided, the method comprising opening an organ transportation apparatus, the apparatus comprising at least one cooling pack, a first receptacle configured to hold at least a first organ type, and a second receptacle configured to hold at least a second organ type; in accordance with the one or more organs being the first type of organ, positioning one or more bags containing the one or more organs within the first receptacle and closing the organ transportation apparatus with both the first receptacle and the second receptacle within the organ transportation apparatus; in accordance with the one or more organs being the second type of organ, positioning one or more bags containing the one or more organs within the second receptacle and closing the organ transportation apparatus with the second receptacle in the organ transportation apparatus but not the first receptacle; and transporting the organ transportation apparatus to a transplantation site.

In some embodiments, the organ transportation apparatus is configured to maintain the one or more organs at a temperature of 8 to 12 degrees C. during storage. In some embodiments, the organ transportation apparatus does not contain any ice at any time during storage of the one or more organs. In some embodiments, the method further comprises removing the upper receptacle after opening. In some embodiments, the method further comprises removing at least one bag containing organ preservation fluid from the compartment. In some embodiments, the method further comprises using at least a portion of the organ preservation fluid in the at least one bag containing organ preservation fluid to flush at least one of the one or more organs. In some embodiments, the method further comprises placing the one or more organs in at least one bag containing organ preservation fluid and sealing the bag. In some embodiments, the method further comprises perfusing at least one of the one or more organs with an organ perfusion solution.

In some embodiments, a method for organ transportation is provided, the method comprising loading an organ transportation apparatus with at least one bag of organ preservation fluid, the apparatus comprising an insulating enclosure comprising a compartment; a lower receptacle positionable in the compartment configured to hold at least a first type of organ; and an upper receptacle positionable in the compartment above the at least one lower receptacle and configured to hold at least a second type of organ; loading the organ transportation apparatus with at least one cooling pack; loading the organ transportation apparatus with the lower receptacle and the upper receptacle; and closing the organ transportation apparatus for sending to a transplantation site.

In some embodiments, the method further comprises storing the at least one bag of organ preservation fluid at a specified temperature prior to loading into the organ transportation apparatus. In some embodiments, the method further comprises storing the at least one cooling pack at a specified temperature prior to loading into the organ transportation apparatus. In some embodiments, the specified temperature is 2-6 C. In some embodiments, the at least one cooling pack is loaded into the bottom of the compartment. In some embodiments, the at least one cooling pack is loaded into a bottom portion of the compartment. In some embodiments, the at least one cooling pack is loaded into a lid of the compartment. In some embodiments, both the upper receptacle and the lower receptacles are positioned in the compartment, wherein the upper receptacle is positioned above the lower receptacle.

In some embodiments, the method further comprises attaching a temperature monitor to the lower receptacle, wherein the temperature monitor comprises a removable temperature probe. In some embodiments, loading with the at least one bag of organ preservation fluid, loading the at least one cooling pack, and loading the lower receptacle and the upper receptacle comprises first, loading at least one of the at least one cooling packs; second, loading the lower receptacle; third, loading the at least one bag of organ preservation fluid; fourth, loading the upper receptacle; and fifth, loading at least one of the at least one cooling packs.

In some embodiments, any of the features of any of the embodiments described above and/or described elsewhere herein may be combined, in whole or in part, with one another. Additional advantages will be readily apparent to those skilled in the art from the following figures and detailed description. The aspects and descriptions herein are to be regarded as illustrative in nature and not restrictive.

### BRIEF DESCRIPTION OF THE FIGURES

A better understanding of the features and advantages of the present disclosure will be obtained by reference to the following detailed description that sets forth illustrative embodiments, in which the principles of the disclosure are utilized, and the accompanying figures of which:

FIG. 1 is a diagrammatic illustration of an exemplary method of storing a donor organ prior to implantation into an organ recipient, according to some embodiments.

FIG. 2 illustrates a cross-sectional view of an exemplary organ transportation apparatus containing both the upper and lower receptacles, according to some embodiments.

FIG. 3 illustrates a top view of an exemplary organ transportation apparatus where the upper receptacle has been removed, according to some embodiments.

FIG. 4 illustrates an exemplary lower receptacle, according to some embodiments.

FIGS. 5A and 5B illustrate two views of an exemplary upper receptacle. FIG. 5A illustrates a view from above the exemplary upper receptacle, according to some embodiments.

FIG. 5B illustrates a view from below the exemplary upper receptacle, according to some embodiments.

FIGS. 6A and 6B illustrate two views of another exemplary embodiment of an upper receptacle. FIG. 6A illustrates a view from above the exemplary upper receptacle, according to some embodiments. FIG. 6B illustrates a cross-sectional view of the upper receptacle housed within the compartment, according to some embodiments.

FIGS. 7A and 7B illustrate two views of another exemplary embodiment of an upper receptacle. FIG. 7A illustrates a view from above the exemplary upper receptacle, according to some embodiments. FIG. 7B illustrates a cross-sectional view of the upper receptacle housed within the compartment, according to some embodiments.

FIG. 8 illustrates an exemplary compartment lid with a retainer for holding at least one cooling pack, according to some embodiments.

FIGS. 9A and 9B illustrate two views of an exemplary organ transportation apparatus containing both the upper and lower receptacles. FIG. 9A illustrates a top-down view of the exemplary organ transportation apparatus where the temperature probe has been attached, according to some embodiments. FIG. 9B illustrates a cross-sectional view of the exemplary organ transportation apparatus where the temperature probe has been attached, according to some embodiments.

FIG. 10 is a flow diagram of an exemplary method for organ transportation that may involve an organ transportation apparatus such as those illustrated in FIGS. 2, 3, 9A, and 9B, according to some embodiments.

FIG. 11 is a flow diagram of an exemplary method for organ transportation in which an organ transportation apparatus such as those illustrated in FIGS. 2, 3, 9A, and 9B is loaded, according to some embodiments.

### DETAILED DESCRIPTION

Described herein are devices and methods for preserving one or more organs for transplantation. The one or more donor organs may be stored in an organ transportation apparatus configured to safely transport a variety of different types of organs and maintain the one or more donor organs temperature within a predetermined range of temperatures. The organ transportation apparatus may have a compartment configured to house at least one upper receptacle and at least one lower receptacle. Each receptacle may be configured to house a different type of organ, and the compartment may be configured to house multiple receptacles at a given time. The type of receptacle needed may be chosen based on the type of donor organ that will be transported and/or stored, and receptacles not transporting and/or storing a donor organ may be removed or left within the compartment. The apparatus may also be configured to house additional bags of organ preservation fluid which may be used to flush the one or more donor organs.

The organ transportation apparatus may be configured to support and stabilize the receptacles housed within it. For example, the receptacles may sit on a series of shelves, they may be housed between other receptacles to prevent excessive movement, and/or they may be placed between another receptacle and a cooling pack and/or a retainer holding cooling packs. The receptacles may be shaped and/or sized in different ways to house different types of organs. The receptacles may also be shaped and/or sized for partially or wholly housing an organ. The receptacles may be configured to attach to and/or receive a temperature sensor, for example a temperature probe, an infrared thermometer, and/or a thermocouple, that may monitor the temperature of a donor organ that may be placed within a sealed bag within a receptacle. Such temperature monitoring may allow organ transportation personnel to ensure that the organ remains at a suitable temperature.

The one or more donor organs may be stored in an organ transportation apparatus configured to maintain the one or more donor organs at a temperature that may be higher than a temperature achievable by conventional methods. Conventional donor organ storage methods include storing the one or more donor organs in a cooler on ice. These conventional methods can only preserve a donor organ for a limited period of time. By storing the one or more donor organs at a cool temperature that may be higher than that achievable with ice, according to the principles described herein, the one or more donor organs can be stored for longer periods of time. Increasing the amount of time that a donor organ can be stored can increase the one or more donor organs pool because, for example, organ donors and organ recipient can be located farther apart.

Static cold storage that includes storing a donor organ in a cooler on ice may be a standard preservation technique and may be used to store many donor organs. The goal of such static cold storage may be to sustain cellular viability by reducing cellular metabolism. Static cold storage has historically been used to preserve donor lungs. Specifically, donor lungs may be typically preserved in a cooler on ice until they can be transplanted into a recipient. A cooler with ice typically stores the donor lung at temperatures of 2-6 degrees C. However, not only does this technique only allow the donor lung to be preserved for short periods (e.g., less than 6-8 hours), it also reduces the viability of the donor lung by damaging the lung's mitochondrial health. This may be problematic because mitochondrial health of a donor lung has been shown to have a direct effect on the success rate of the lung transplantation. Thus, a lung having a compromised mitochondrial health may be more likely to also have a compromised transplantation outcome.

However, preserving donor lungs using static cold storage at slightly higher temperatures (e.g., 8-12 degrees C.), according to the principles described herein, can achieve longer preservation periods, such as preservation periods of greater than 6-8 hours, while still achieving successful transplantation outcomes. This higher temperature maintains the mitochondrial health of the donor lung better than that of static cold storage at the lower temperature. For example, the inventors have discovered that the levels of the mitochondrial-related metabolites itaconate, glutamate, and N-acetylglutamine may be greater in donor lungs that have been preserved for 36 hours at 10 degrees C., according to the methods, systems, and devices described herein, than in donor lungs that have been preserved at 4 degrees C. according to conventional methods and devices. The higher levels of these mitochondrial-related metabolites after preservation indicate that donor lungs preserved using static cold storage for 36 hours at 10 degrees C., according to the devices and methods described herein, have improved mitochondrial health relative to donor lungs preserved at 4 degrees C. Thus, static cold storage preservation at higher temperatures, according to the principles described herein, may be able to achieve longer preservation periods while better maintaining the mitochondrial health of donor lungs.

An organ transportation apparatus for storing a donor organ at temperatures that prolong storage time, as discussed above, can include one or more cooling packs that may be configured to keep a donor organ stored in the organ transportation apparatus cool but at a temperature above that achieved using ice. These cooling packs may be placed in different locations within the organ transportation apparatus (e.g., in the top, in the bottom, in a retainer on the lid). The cooling packs may be spaced in such a way that they help keep receptacles in place within the compartment while also allowing for airflow. A donor organ can be sealed within at least one bag and placed in a receptacle of the organ transportation apparatus. Organ preservation solution can be included in the at least one bag so that the one or more donor organs may be in direct contact with the preservation solution.

The organ transportation apparatus can be configured to store organ preservation solution prior to use. The organ transportation apparatus with the stored organ preservation solution can be shipped to a site of an organ donor. A portion of the organ preservation solution can then be used to flush the one or more donor organs prior to placing the one or more donor organs in one or more bags containing organ preservation solution.

The devices and methods provided herein may be used to preserve any organ suitable for transplantation. Some examples described below use lungs and/or hearts as an example of an organ suitable for preservation using the devices and methods described herein. However, other suitable organs include, but are not limited to, kidneys, livers, and pancreas.

In the following description, it is to be understood that the singular forms “a,” “an,” and “the” used in the following description are intended to include the plural forms as well, unless the context clearly indicates otherwise. It is also to be understood that the term “and/or” as used herein refers to and encompasses any and all possible combinations of one or more of the associated listed items. It is further to be understood that the terms “includes, “including,” “comprises,” and/or “comprising,” when used herein, specify the presence of stated features, integers, steps, operations, elements, components, and/or units but do not preclude the presence or addition of one or more other features, integers, steps, operations, elements, components, units, and/or groups thereof.

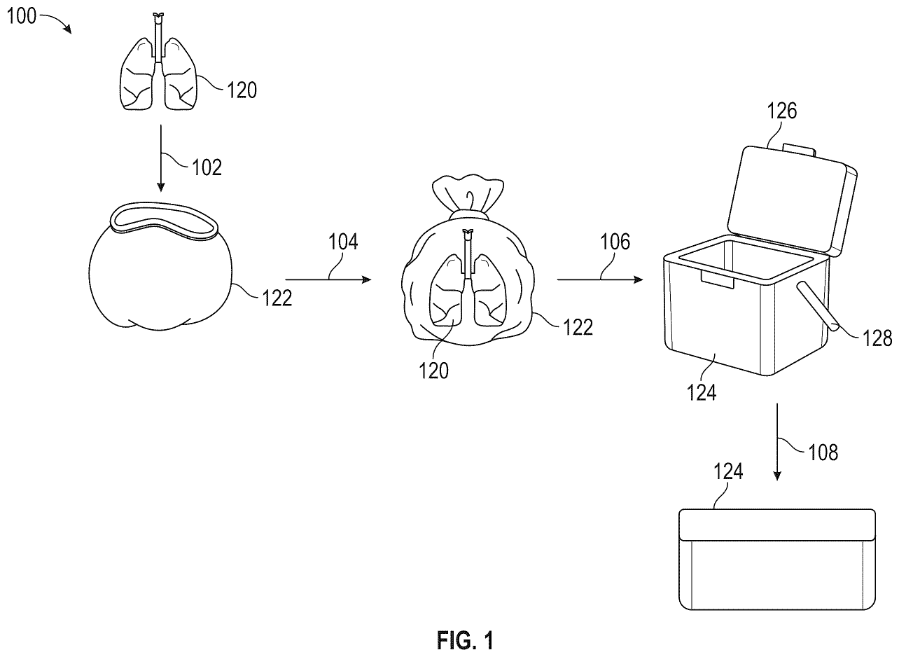

FIG. 1 is a diagrammatic illustration of a method 100 of storing a donor organ prior to implantation into an organ recipient, according to an aspect of the present disclosure. At step 102, one or more donor organs 120 that has been removed from an organ donor may be bagged by placing the one or more donor organs into at least one bag 122. The one or more donor organs 120 can be placed in multiple bags. For example, the one or more donor organs 120 can be placed in an inner bag which may be located within one or more additional bags. In some examples, the one or more donor organs 120 may be placed within three bags. At step 104, organ preservation solution may be added to the at least one bag 122 before sealing the at least one bag 122. When multiple bags are used, each bag can be sealed separately (e.g., an inner bag can be sealed and then an outer bag can be sealed) or the multiple bags can be sealed together (e.g., a tie can be tied around the bags simultaneously).

In some implementations, multiple organs may be placed within one or more bags as described above for storage within an organ transportation apparatus 124 at step 106. For example, instead of storing a left lung and right lung together in one or more bags, a left lung may be placed in one or more bags and a right lung may be placed in one or more separate bags. In this example, the one or bags containing the left lung and the one or more separate bags containing the right lung may both be sealed and placed within organ transportation apparatus 124 as described in further detail below.

At step 106, the at least one sealed bag 122 with the one or more donor organs 120 within may be placed into organ transportation apparatus 124. The organ transportation apparatus 124 can be configured to maintain the one or more donor organs at a cool temperature but above a temperature that the one or more donor organs would reach if ice were used within the organ transportation apparatus 124, as in conventional methods. For example, the organ transportation apparatus 124 can be configured to maintain the one or more donor organs at a temperature that may be at least 8 degrees C. during storage. The organ transportation apparatus 124 may include one or more cooling packs that, together with the insulative construction of the walls of the organ transportation apparatus 124, maintain the one or more donor organs at a temperature that may be at least 2 degrees C. for a desired storage period. Additionally or alternatively, the organ transportation apparatus 124 may include a powered cooling system, such as a battery-powered refrigeration system. Such a battery-powered refrigeration system may comprise a compressor powered by a battery pack and used to pressurize coolant moving between a condenser and evaporator that, along with cooling fans, enable transfer of heat from the interior of the organ transportation apparatus to the external environment. The organ transportation apparatus 124 can be closed, such as by closing a lid 126 of the organ transportation apparatus 124. At step 108, the one or more donor organs 120 may be stored in the organ transportation apparatus 124 for a storage period.

An organ transportation apparatus 124 with a donor organ stored within can be placed in a storage location of the same facility in which the one or more donor organs was removed from the organ donor until an organ recipient may be ready for transplantation. Additionally, or alternatively, the organ transportation apparatus 124 can be transported to a different facility, such as to a storage facility or to a facility where the organ recipient will receive the transplant. For example, the organ transportation apparatus 124 with a donor organ stored within can be loaded onto one or more vehicles, such as one or more cars, trucks, buses, and/or aircraft, and transported to a storage facility and/or to a location where the one or more donor organs will be transplanted into the organ recipient. The organ transportation apparatus 124 may be configured to be hand carried (e.g., may include a handle 128 for a carrier to carry the organ transportation apparatus 124).

At a suitable time, the one or more donor organs 120 may be removed from the organ transportation apparatus 124. The one or more donor organs 120 may be transplanted into an organ recipient. Prior to transplanting the one or more donor organs in the organ recipient, the one or more organs may undergo one or more preparation procedures. For example, the one or more donor organs may be perfused with perfusion solution to increase the healthiness and/or to repair the one or more donor organs.

The one or more donor organs 120 may be removed from the organ transportation apparatus 124, undergo one or more procedures, and then placed back into the organ transportation apparatus 124 for additional storage. For example, the one or more donor organs 120 may be removed from the organ transportation apparatus 124, connected to an organ perfusion system, perfused with an organ perfusion solution to increase the amount of time the one or more donor organs can be preserved, and then placed back in the organ transportation apparatus 124 for additional storage. During perfusion of the one or more donor organs, a temperature of the one or more donor organs may be increased, such as to a normothermic temperature, and then decreased back to a suitable temperature (e.g., 8-12 degrees C.) for storage in the organ transportation apparatus 124. This process may be repeated multiple times. Perfusion of the one or more organs may at occur after the one or more organs have been transported to the transplantation site and/or at a third location that the one or more organs is transported to from the donation site and before reaching the transplantation site. For example, the third location may be a third-party location. In this way, perfusion may improve the preservation of the one or more organs, helping it remain viable while a recipient is located and/or prepared for surgery.

Though minimizing the period of storage of a donor organ may be generally preferable, the maximum period of storage of the one or more donor organs in the organ transportation apparatus provided by the storage methods and/or organ transportation apparatuses described herein can be at least 2 hours, preferably at least 4 hours, more preferably at least 6 hours, more preferably at least 8 hours, more preferably at least 10 hours, more preferably at least 12 hours, more preferably at least 14 hours, more preferably at least 16 hours, more preferably at least 24 hours, more preferably at least 30 hours, more preferably at least 36 hours, more preferably at least 42 hours, and/or more preferably at least 48 hours. The maximum period of storage of the one or more donor organs in the organ transportation apparatus provided by the storage methods and/or organ transportation apparatuses described herein can be up to 8 hours, preferably up to 10 hours, more preferably up to 12 hours, more preferably up to 14 hours, more preferably up to 16 hours, more preferably up to 24 hours, more preferably up to 30 hours, more preferably up to 36 hours, more preferably up to 42 hours, and/or more preferably up to 48 hours.

The organ transportation apparatus (including one or more cooling packs or other cooling features) can be configured to maintain the one or more donor organs while stored in the organ transportation apparatus at a temperature of at least 6 degrees C., at least 8 degrees C., and/or at least 10 degrees C. The organ transportation apparatus can be configured to maintain the one or more donor organs at a temperature of up to 8 degrees C., up to 10 degrees C., up to 12 degrees C., and/or up to 14 degrees C. The organ transportation apparatus can be configured to maintain a donor organ within a temperature range of 6-14 degrees C., 7-13 degrees C., 8-12 degrees C., and/or 9-11 degrees C. The organ transportation apparatus can be configured (e.g., via insulative characteristics, configuration of cooling packs, number of cooling packs, temperature of cooling packs, characteristics of phase-change material within cooling packs, etc.) to maintain the one or more donor organs at any of the above temperatures and temperature ranges for at least a predetermined minimum period of time, such as a period of at least 1 hour, at least 2 hours, preferably at least 4 hours, more preferably at least 6 hours, more preferably at least 8 hours, more preferably at least 10 hours, more preferably at least 12 hours, more preferably at least 14 hours, more preferably at least 16 hours, more preferably at least 24 hours, more preferably at least 30 hours, more preferably at least 36 hours, more preferably at least 42 hours, and/or more preferably at least 48 hours. The organ transportation apparatus can be configured to maintain the one or more donor organs at any of the above temperatures and temperature ranges for a period of up to 8 hours, preferably up to 10 hours, more preferably up to 12 hours, more preferably up to 14 hours, more preferably up to 16 hours, more preferably up to 24 hours, more preferably up to 30 hours, more preferably up to 36 hours, more preferably up to 42 hours, and/or more preferably up to 48 hours.

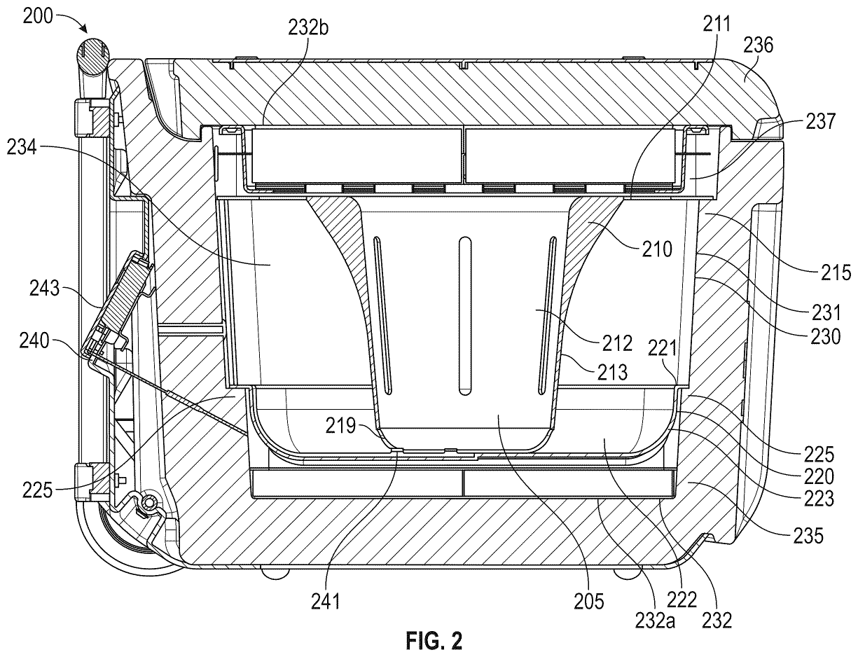

FIG. 2 illustrates an example of an organ transportation apparatus that may form organ transportation apparatus 124 of method 100 and/or may be used as a part of additional organ storage and/or transportation techniques. Organ transportation apparatus 200 is configured for selectively storing different types of organs by including different organ receptacles that can be used depending on the type of organ. Thus, organ transportation apparatus 200 may be used for storing any type of organ by selecting from among the plurality of available receptacles.

Organ transportation apparatus 200 includes an upper receptacle 210 and a lower receptacle 220 housed within a compartment 230. The organ transportation apparatus 200 may include insulated walls 231 forming an insulating enclosure that includes the compartment 230. The walls 231 may be made of or include one or more recyclable materials including, for example, expanded polypropylene, polyethylene, and/or polyvinyl chloride. The walls 231 may include at least one shelf for supporting a receptacle. The at least one shelf may include an upper shelf 215 configured to support the upper receptacle 210. The at least one shelf may include a lower shelf 225 configured to support the lower receptacle. The walls 231 of compartment 230 may be stepped and/or include one or more grooves to provide the at least one upper shelf 215 and/or the at least one lower shelf 225. The compartment 230 may be wider at the at least one upper shelf 215 than at the at least one lower shelf 225.

The interior surfaces of organ transportation apparatus 200 may include one or more liners to reduce exposure of compartment 230 to preservation fluid, and to improve the cleanability of the compartment. For example, the one or more liners may be pouches or bags designed to fit within compartment 230, upper receptacle 210, and/or lower receptacle 220. For example, the one or more liners may be composed of a biocompatible, recyclable plastic material such as polyethylene, polypropylene, and/or nylon.

The upper receptacle 210 may have at least one flange 211 that may be configured to sit on at least one upper shelf 215 of compartment 230. This may enable the upper receptacle 210 to be suspended within the compartment 230 (e.g., suspended above the lower receptacle 220 such that it does not touch the lower receptacle 220).

The lower receptacle 220 may have at least one flange 221. The at least one flange 221 may be configured to sit on the at least one lower shelf 225 of compartment 230. This may enable the lower receptacle 220 to be suspended within the compartment 230 (e.g., such that it does not touch the bottom of the compartment 230).

The upper receptacle 210 may have at least one wall 213 defining a chamber 212 for at least partially housing an organ. The lower receptacle 220 may also have at least one wall 223 defining a chamber 222 for at least partially housing an organ. The upper receptacle 210 may be configured to house a smaller type of organ (e.g., a heart) than the lower receptacle 220. In some embodiments, chamber 212 of the upper receptacle has a first width and a first height, and lower chamber 222 has a second width and a second height different from the first width and first height. In some embodiments, the second height may be shorter than the first height. In some embodiments, the second width may be wider than the first width. In some embodiments, the second width being wider than the first width may mean the chamber 212 of the upper receptacle 210 is narrower than the chamber 222 of the lower receptacle 220 which may enable the upper receptacle 210 to house a smaller type of organ (e.g., a heart) than the lower receptacle 220. This may enable the smaller organ (e.g., a heart) to be firmly retained within the upper receptacle 210 and prevent the organ from moving around, helping prevent an organ from becoming damaged or unusable for organ transplantation. In some embodiments, the second width being wider than the first width may mean that the chamber 222 of the lower receptacle 220 is wider than the chamber 212 or the upper receptacle 210 which may enable the lower receptacle 220 to house a larger type of organ (e.g., a lung) than the upper receptacle 210. In some embodiments, the second height being shorter than the first height may mean that the lower receptacle 220 is optionally shallower than the upper receptacle 210. This may enable the lower receptacle 220 to only partially house the organ within the chamber 222. The part of the organ that may not be encompassed by the lower receptacle 220 may instead be surrounded on the sides by the walls 231 of the compartment 230.

The compartment 230 may also include at least one cooling pack 232. The at least one cooling pack 232 may be configured to maintain a temperature within the organ transportation apparatus 200 within a range that may be suitable for storing a donor organ for a desired amount of time. For example, the at least one cooling pack 232, when placed within the organ transportation apparatus 200, may be configured to maintain a temperature within the organ transportation apparatus 200 that may be within any of the ranges described above and for any of the time periods described above. The at least one cooling pack 232 can include a phase-change material having a transition temperature of at least 0 degrees C. The at least one cooling pack 232 may be configured to transition from solid to liquid in a range of 6-12 degrees C., preferably in a range of 8-10 degrees C., such as around 8 degrees C. or around 10 degrees C. (in this context, around means plus or minus less than 1 degree C.).

Optionally, the phase-change material may be plant-derived (e.g., bio-based), such as materials derived from renewable and environmentally friendly resources, including food-grade materials such as palm kernel oil, palm oil, coconut oil, and soybean oil. The phase-change material may include at least one color-sensitive dye that changes color depending on the temperature of the phase-change material. The dye may be a first color when the phase-change material may be in a solid state and may be a second color when the phase-change material may be in a liquid phase. The phase-change material may be contained within a housing that permits observation of the color of the phase-change material (e.g., the housing may be transparent or translucent). Optionally, the phase-change material includes several different dyes that have different color-change temperatures so that an observer may ascertain a more accurate estimate of the temperature of the cooling pack. This may be particularly useful for enabling a user to know how long to keep the cooling pack in a refrigerator before using it in the organ transportation apparatus. The color-changing dye may change color to indicate when it has reached the maximum temperature for use in an organ transportation apparatus. For example, it may be desirable for a cooling pack to be cooled to 4 degrees C. before placement into an organ transportation apparatus, and the phase-change material may include a dye that changes color at 4 degrees C. so that the user knows when it is cool enough to use. One or more dyes that change color at temperatures above the transition temperature of the phase-change material may be used so that a user can readily ascertain the temperature reached within the organ transportation apparatus toward the end of a storage session.

The number of cooling packs 232 within the organ transportation apparatus 200 may be selected based on an expected time that the cooling packs 232 will need to maintain the desired temperature. For example, the number of cooling packs 232 can be selected based on an “expected total cooling time” that may be the time for the organ transportation apparatus 200 to be transported to a site of a donor, loaded with a donor organ, and transported to a site of an organ recipient. The number of cooling packs 232 can be linearly associated with the expected total cooling time. For example, twice as many cooling packs 232 may be needed for twice the expected cooling time.

The compartment 230 may be configured to house multiple cooling packs 232. For example, the compartment may include an interior bottom 235 of the compartment 230 that may house at least one lower cooling pack 232a. The at least one lower cooling pack 232a may be configured to sit below the lower receptable 220 in the compartment 230. The at least one lower cooling pack 232a may be positioned such that there may be space between the lower receptacle 220 and the at least one lower cooling pack 232a such that no direct contact is made, and cooled air may flow freely.

The compartment 230 may also include a lid 236 with a retainer 237 configured to house at least one cooling pack 232. The at least one cooling pack 232 may be an at least one upper cooling pack 232b. The at least one upper cooling pack 232b may be configured to be suspended by the retainer 237 above the upper receptable 210 in the compartment 230. The at least one upper cooling pack 232b may be positioned such that there may be space (e.g., resulting from the presence of retainer 237) between the upper receptacle and the at least one upper cooling pack 232b such that no direct contact may be made, and cooled air may flow freely. In some embodiments, the retainer 237 may be positioned such that it prevents significant vertical movement of the upper receptacle 210 within the compartment 230. In some embodiments, the upper receptacle 210 may be positioned between and held in place by at least one upper shelf 215 and retainer 237. This may prevent significant vertical movement of upper receptacle 210 within the organ transportation apparatus without the addition of other, more complex components and/or attachment hardware.

The compartment 230 may be sized and shaped to fit a bagged donor organ. Optionally, the compartment 230 may be sized and shaped to closely fit the bagged donor organ to minimize movement of the organ during transport.

The organ transportation apparatus 200 may be used to transport one or more bags of organ preservation fluid and one or more cooling packs to maintain the organ preservation fluid at a desired temperature, as described above. To prepare the bags of organ preservation fluid and cooling packs 232 for transport, cooling packs 232 and/or organ preservation fluid bags may be conditioned by storing in one or more refrigerators. Storing within a refrigerator may allow the one or more cooling packs 232 and/or the one or more organ preservation fluid bags to reach a specified temperature. For example, this specified temperature may be between 2 C and 6 C. For example, this specified temperature may be at least 0 C, at least 1 C, at least 2 C, at least 3 C, at least 4 C, at least 5 C, at least 6 C, at least 7 C, at most 8 C, at most 7 C at most 6 C, at most 5 C, at most 4 C, at most 3 C, and/or at most 2 C. For example, this specified temperature may be a function of the projected external temperature of organ transportation apparatus 200 during transportation and/or the transportation time associated with transportation of the apparatus to the donation site and from the donation site to the transplantation site. For example, to store cooling packs 232 and/or the organ preservation fluid bags at a desired temperature, the specified temperature may be 4 C.

The one or more organ preservation fluid bags can be placed in the organ transportation apparatus 200 when the organ transportation apparatus 200 is prepared for transportation to a donor site. For example, a member of an organ retrieval team may prepare the organ transportation apparatus 200 by removing the organ preservation fluid bags from a refrigerator and placing the organ preservation fluid bags in the organ transportation apparatus 200. The member of the organ retrieval team may remove any suitable number of cooling packs 232 from a refrigerator (e.g., the same refrigerator from which the organ preservation fluid bags were stored and/or a different refrigerator at a different temperature) and place them in the organ transportation apparatus 200.

Cooling packs 232 and/or organ preservation fluid bags may then be removed from the one or more refrigerators and placed in the organ transportation apparatus 200. The organ transportation apparatus 200 may then be closed and transported to the donor site. Optionally, after the cooling packs 232 have been used to transport an organ, the cooling packs 232 may be returned to the one or more refrigerators for cooling back to the desired temperature. Alternatively or additionally, one or more of the cooling packs 232 may be discarded.

The organ transportation apparatus 200 can be used to store one or more organ storage bags (e.g., bag 122 of FIG. 1) filled with preservation fluid. The one or more organ storage bags may be used at the donor site to hold the one or more donor organs as described above with respect to step 102 of method 100. The one or more organ storage bags can be placed in the organ transportation apparatus 200 when the organ transportation apparatus 200 is prepared for transporting to a donor site. For example, the organ transportation apparatus 200 may be prepared to be sent to a donor site by placing the organ storage bags (optionally containing preservation fluid) in the organ transportation apparatus 200 (e.g., along with the cooling packs 232). In the example illustrated in FIG. 2, one or more organ storage bags filled with preservation fluid may be positioned in a space 234 between wall 213 of upper receptacle 210 and/or within the chamber 212 of the upper receptacle 210.

At the donor site, to prepare the one or more donor organs for transport in organ transportation apparatus 200, the organ may be removed from the donor, for example the organ may be explanted. The organ storage bags filled with preservation fluid can be removed from the organ transportation device 200 and the one or more donor organs can be flushed with the organ preservation fluid from the organ storage bags. An organ can then be sealed along with the organ preservation fluid in the organ storage bags, and the bagged donor organ can be placed within the organ transportation apparatus 200. The lid 236 of the organ transportation apparatus 200 can then be closed and the one or more donor organs stored within the organ transportation apparatus 200 for a desired amount of time. Prior to a bagged donor organ being placed into organ transportation apparatus 200, for example during transport of the apparatus to the donor site, the temperature within organ transportation apparatus 200 may be between 4 C and 8 C. Following insertion of a bagged donor organ, the temperature within organ transportation apparatus 200 may be higher. For example, the temperature within the apparatus following insertion of a bagged donor organ may initially be approximately 6 C, and may rise to between 8 C and 12 C as the apparatus is transported to the transplantation site.

The organ transportation apparatus 200 may include one or more monitoring units 240 that may monitor one or more parameters of the organ transportation apparatus 200 and/or one or more aspects of its use. For example, the organ transportation apparatus 200 may include one or more temperature sensors 241 that monitor a temperature within the organ transportation apparatus 200 and/or a temperature of the bagged donor organ contained within the compartment 230. The one or more temperature sensors 241 may be operatively connected to a monitoring unit 240, which may monitor the temperature of the sensors over time. Optionally, a temperature sensor 241 may contact the bagged donor organ. For example, the temperature sensor 241 may be positioned so that the bagged donor organ sits at least partially on top of the temperature sensor 241 such that contact may be maintained between the bagged donor organ and the temperature sensor 241 due to gravity. The temperature sensor 241 may include, for example, a temperature probe, an infrared thermometer, and/or a thermocouple.

In some embodiments, the temperature sensor 241 may be positioned such that contact may be maintained between the bagged donor organ and the temperature sensor 241 regardless of whether the bagged donor organ is housed within the upper receptacle 210 or the lower receptacle 220. The temperature sensor 241 may be configured to attach to the lower receptacle 220. The temperature sensor 241 may be attached to the lower receptacle 220 in such a way as to allow the temperature sensor to also sit within the upper receptacle 210. There may be an aperture 219 on the upper receptacle 210 configured to receive the temperature sensor 241 attached to the lower receptacle 220 such that the temperature sensor 241 can make contact with or otherwise measure the temperature of a bagged organ in the upper receptacle 210.

The monitoring unit 240 may include a display 243 for displaying one or more of the monitored parameters. For example, the display 243 may be used to display a temperature (e.g., a current temperature or a max temperature of temperature sensor 241). In some examples, the monitoring unit 240 stores temperature readings for later retrieval.

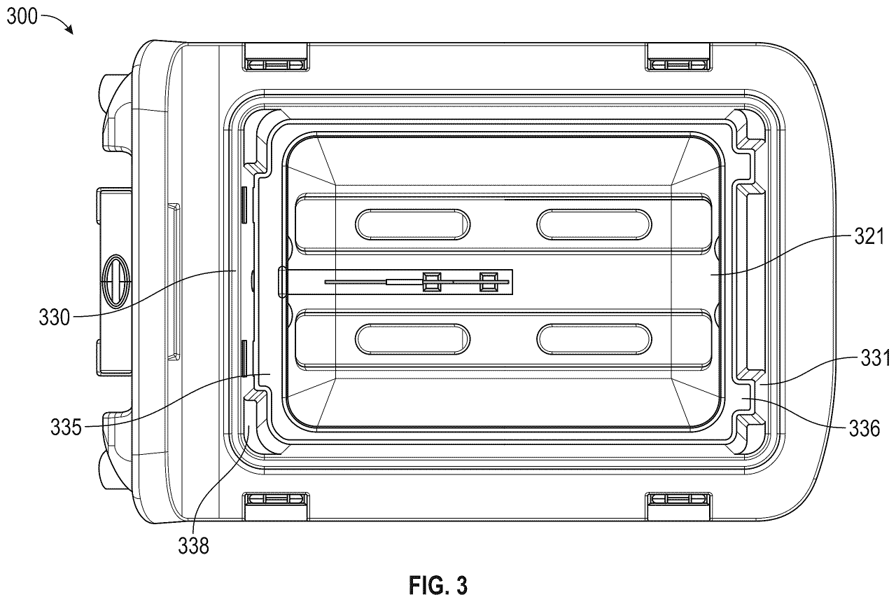

The receptacles of the organ transportation apparatus may be removable, as shown in FIG. 3, which illustrates a top view of an exemplary organ transportation apparatus 300 where the upper receptacle has been removed. FIG. 3 may represent a top view of the embodiment shown in FIG. 2 but with the upper receptacle 210 removed. In some embodiments, the organ transportation apparatus 300 has receptacles which may be removable including, for example, lower receptacle 321. Thus, at any given moment, the organ transportation apparatus 300 may have at most two, at most one, at least two, or at least one receptacles within its compartment 330. When one or more receptacles are removed, the resulting space may be used to contain additional bags of organ preservation fluid.

When receptacles are added to the organ transportation apparatus 300, they may be configured to rest on shelves 338. These shelves 338 may protrude from the walls 331 of the compartment 330 such that they may be configured to support the receptacles. Shelves 338 may include shelves 215 and 225 of organ transportation device 200. The shelves 338 may protrude different amounts from the walls 331 depending on the receptacle they may be configured to support. At least one of the shelves 338 may be a lower shelf which may be formed by one or more slots in the wall 331. In some embodiments, at least one of the slots in the wall may be a wide slot 335 and at least one (e.g., in some embodiments, two) of the slots may be a narrow slot 336. These slots may enable the lower receptacle 321 to slide down into the compartment 330 past any upper shelves. In some embodiments, these shelves 338 have no sharp edges, points, or protrusions. This may ensure that the bags of organ preservation fluid or bags containing donor organs do not tear, rupture, pop, or otherwise become damaged. This may also ensure that the shelves 338 do not poke, prod, touch, or otherwise damage organs contained within the receptacles.

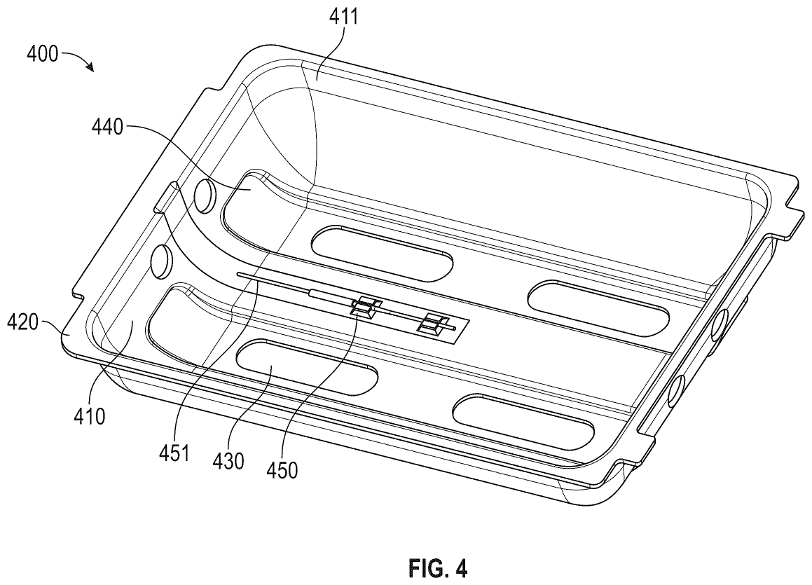

Each of these receptacles may be configured to house different types of organs. FIG. 4 illustrates an exemplary lower receptacle 400 which may be configured to transport a first type of organ. In some embodiments, the first type of organ may be one or more lungs, for example a left lung and/or a right lung. In some embodiments, the first type of organ may be one or more portions of a lung, for example one or more lobes of a lung that may be used in a lobular lung transplant. In some embodiments, each of the one or more lungs and/or one or more lobes of a lung may be bagged separately, and placed within the lower receptacle 400.

The lower receptacle 400 may include a chamber 410 to house the first type of organ. The chamber 410 may comprise at least one wall 411 defining the chamber 410. In some embodiments, the at least one wall 411 may be sized to only partially accommodate the first type of organ within. The first type of organ (e.g., a lung) may be of such a size that it does not fit entirely within the chamber 410 of the lower receptacle 400 and extends out of the lower receptacle 400. Additionally or alternatively, in some embodiments, the at least one wall 411 may be sized to fully accommodate the first type of organ within, and the at least one wall 411 may be of such a height that it extends all the way up to an upper shelf within the compartment. The first type of organ (e.g., a lung) may be of such a size that it fits entirely within the chamber 410 of the lower receptacle 400 and does not extend out of the lower receptacle 400.

The lower receptacle 400 may also have edges 420 configured to sit on a shelf of an organ transportation apparatus to support the lower receptacle 400. In some embodiments, the edges 420 may be at least one lip. The edges 420 may extend out from at least one side of the chamber 410 of the lower receptacle 400. These edges 420 may be rounded and dull as to prevent tearing, puncturing, prodding, or otherwise damaging any bags of organ preservation fluid, bags containing organs, and/or organs contained within the organ transportation apparatus.

The lower receptacle 400 may also have openings 430 on the chamber 410 that may enable cooling of the bags of organ preservation fluid, bags containing donor organs, and/or the surrounding air. This cooling may be a result of, for example, at least one cooling pack placed beneath the lower receptacle 400. The at least one cooling pack may thus reduce the temperatures, for example by thermal conduction, of the lower receptacle 400 and the surrounding air. The reduced temperatures of the lower receptacle 400 and surrounding air may in turn cool any bags of organ preservation fluid and/or bags containing donor organs contained within the lower receptacle 400.

The lower receptacle 400 may also comprise at least one recess 440. This recess 440 may be configured to receive at least one projection from the upper receptacle, providing stability to the upper receptacle. In some embodiments, the at least one recess 440 may be large enough in size such that when the at least one projection from the upper receptacle is housed within the recess 440, the at least one projection does not make contact with the lower receptacle 400. This may ensure that when both the upper receptacle and lower receptacle 400 are housed within an organ transportation apparatus, the upper receptacle may have limited horizontal movement within the compartment of the organ transportation apparatus without requiring that the receptacles lock together.

The lower receptacle 400 may also comprise temperature sensor attachment hardware 450 configured to attach a temperature sensor 451 to the lower receptacle 400. The temperature sensor attachment hardware 450 may comprise a series of clips, latches, bolts, fasteners, and/or other attachment hardware. The temperature sensor 451 may be attached to the lower receptacle 400 by the attachment hardware 450 such that the temperature sensor 451 can make contact with a bag containing organ preservation fluid and/or a bag containing a donor organ housed within the lower receptacle 400. The temperature sensor 451 may be connected to an external temperature monitor (not shown). The lower receptacle 400 may be rectangular in shape. In some embodiments, the lower receptacle 400 may have at least two walls 411 which may be longer than at least two other of the walls 411 defining the chamber 410. In some embodiments, the lower receptacle 400 may be a shallow tray.

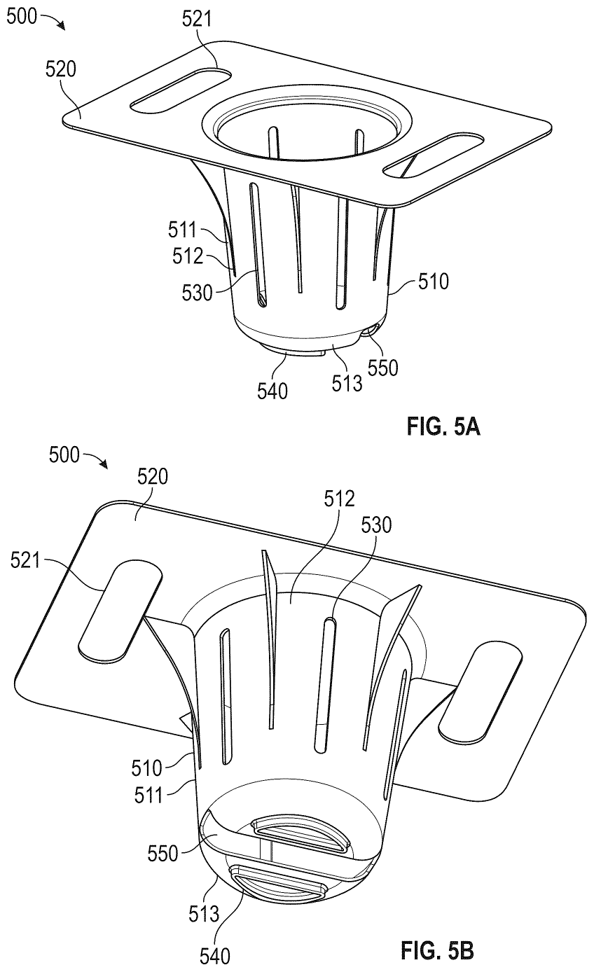

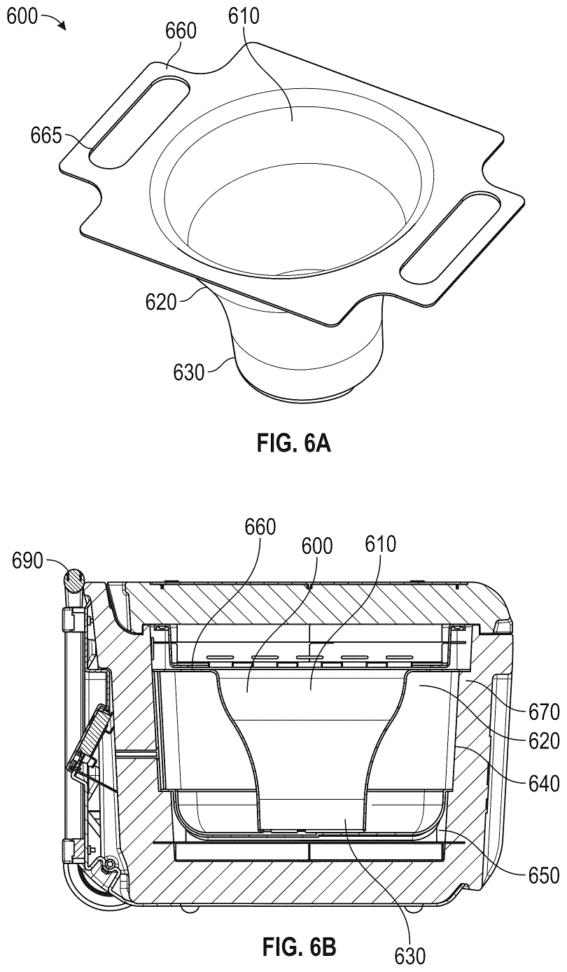

Other receptacles may be configured to house other types of organs. For example, FIGS. 5A and 5B illustrate two views of an exemplary upper receptacle 500 which may be configured to transport a second type of organ. In some embodiments, the second type of organ may be a heart. In some embodiments, the second type of organ may be a kidney. In some embodiments, the second type of organ may be a liver.

The upper receptacle 500 may comprise a chamber 510 to house the second type of organ. The chamber 510 may comprise at least one wall 511 defining the chamber 510. In some embodiments, the at least one wall 511 may be sized to accommodate an entire second type of organ. The second type of organ (e.g., a heart) may be of such a size that it fits wholly within the chamber 510 of the upper receptacle 500 and does not extend out of the upper receptacle 500. It may also be sized such that the chamber 510 has dimensions and a volume similar to the dimensions and volume of the second type of organ such that the second type of organ can be tightly and securely housed within the chamber 510 of the upper receptacle 500.

The upper receptacle 500 may also have flanges 520 configured to sit on a shelf of an organ transportation apparatus to support the upper receptacle 500. The flanges 520 may extend out from at least one side of the chamber 510 of the upper receptacle 500. These flanges 520 may be rounded and dull as to prevent tearing, puncturing, prodding, and/or otherwise damaging any bags of organ preservation fluid, bags containing organs, and/or organs contained within the organ transportation apparatus. In some embodiments, the flanges 520 may have slots 521 that may enable easy removal of the upper receptacle 500 from an organ transportation apparatus. The slots 521 may be sized and shaped such that they could be used as handles for organ transportation personnel to grab and lift the upper receptacle.

The upper receptacle 500 may also have airflow openings 530 on the chamber 510 that enable airflow. The airflow openings 530 may allow for air cooled by cooling packs to pass through the upper receptacle 500, cooling any bags of organ preservation fluid and/or bags containing donor organs contained within the upper receptacle 500. These airflow openings 530 may be thin slits that may be sized such that air may flow through the chamber 510, but any bags of organ preservation fluid, donor organ bags, and/or other material housed within the chamber 510 cannot fall out of the chamber 510.

The upper receptacle 500 may also comprise at least one projection 540. The at least one projection 540 may be configured to extend from the bottom of the chamber 510 into at least one recess on the lower receptacle, providing stability to the upper receptacle 500. In some embodiments, the at least one projection 540 may be small enough in size such that when the at least one projection 540 from the upper receptacle is housed within the recess of the lower receptacle, the at least one projection 540 may not contact the lower receptacle. This may ensure that when both the upper receptacle 500 and lower receptacle are housed within an organ transportation apparatus, the upper receptacle 500 may have limited horizontal movement within the compartment of the organ transportation apparatus without requiring that the receptacles lock together. In some embodiments, the projections 540 may be semi-circular in shape. In some embodiments, there may be more than one set of projections 540, for example there may be two sets.

The upper receptacle 500 may also comprise an aperture 550 configured to receive a temperature sensor which may be attached to the lower receptacle. The aperture 550 may be an elongated opening on the bottom of the chamber 510. The temperature sensor may be attached to the lower receptacle but fit within the aperture 550 of the upper receptacle 500 when both the upper receptacle 500 and the lower receptacle are in the compartment of an organ transportation apparatus such that the temperature sensor can make contact with a bag containing organ preservation fluid and/or a bag containing a donor organ housed within the upper receptacle 500.

The upper receptacle 500 may be cylindrical in shape. In some embodiments, the upper receptacle 500 may have a chamber 510 defined by at least one cylindrical wall 512 and at least one bottom wall 513. The at least one bottom wall 513 may be flat and may comprise the aperture 550. The at least one cylindrical wall 512 may comprise the at least one airflow opening 530.

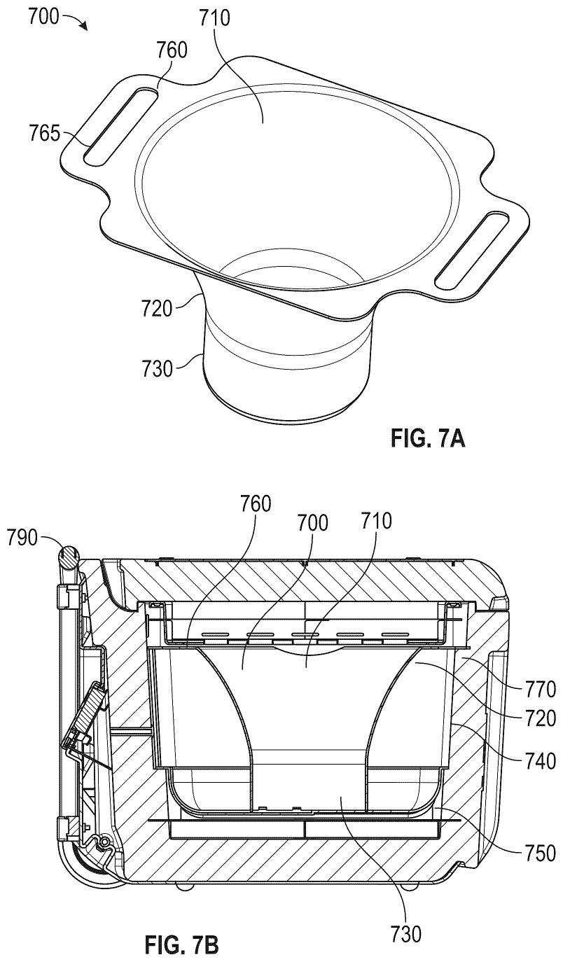

The upper receptacle can have other shapes. FIGS. 6A and 6B illustrate two views of another exemplary embodiment of an upper receptacle 600 which may be configured to transport a second type of organ (e.g., a heart). The embodiment of the upper receptacle 600 as shown in FIGS. 6A and 6B may have a chamber 610 an upper portion 620 having a first diameter and a lower portion 630 having a second diameter. In some embodiments, the second diameter may be smaller than the first diameter. In some embodiments, the upper portion 620 having the first diameter may taper to a second diameter of the lower portion 630. The upper receptacle 600 may also be configured to fit within a compartment 640 with a lower receptacle 650.

The upper receptacle 600 may also have flanges 660 configured to sit on a shelf 670 of an organ transportation apparatus 690 to support the upper receptacle 600. The flanges 660 may extend out from at least one side of the chamber 610 of the upper receptacle 600. These flanges 660 may be rounded and dull as to prevent tearing, puncturing, prodding, and/or otherwise damaging any bags of organ preservation fluid, bags containing organs, and/or organs contained within the organ transportation apparatus 690. In some embodiments, the flanges 660 may have slots 665 that may enable easy removal of the upper receptacle 600 from an organ transportation apparatus 690. The slots 665 may be sized and shaped such that they could be used as handles for organ transportation personnel to grab and lift the upper receptacle 600.

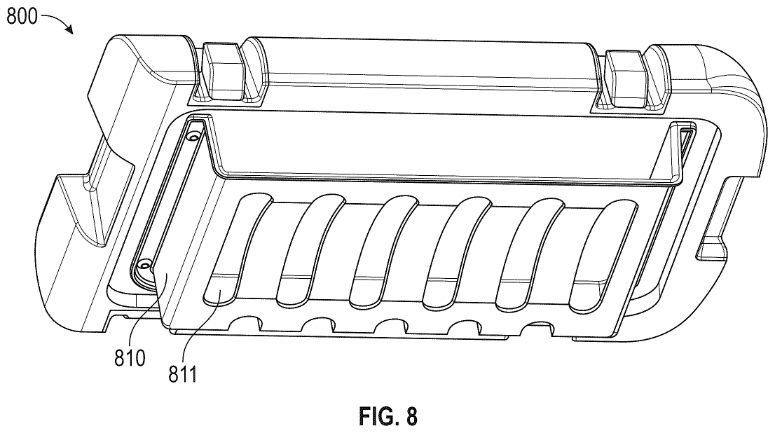

FIGS. 7A and 7B illustrate two views of yet another exemplary embodiment of an upper receptacle 700 which may be configured to transport a second type of organ (e.g., a heart). The embodiment of the upper receptacle 700 as shown in FIGS. 7A and 7B may have a chamber 710 that may be conical in shape. The upper receptacle 700 may have an upper portion 720 having a first diameter and a lower portion 730 having a second diameter. In some embodiments, the second diameter may be smaller than the first diameter. In some embodiments, the upper portion 720 having the first diameter tapers to a second diameter in the lower portion 730. The upper receptacle 700 may also be configured to fit within a compartment 740 with a lower receptacle 750.

The upper receptacle 700 may also have flanges 760 configured to sit on a shelf 770 of an organ transportation apparatus 790 to support the upper receptacle 700. The flanges 760 may extend out from at least one side of the chamber 710 of the upper receptacle 700. These flanges 760 may be rounded and dull as to prevent tearing, puncturing, prodding, and/or otherwise damaging any bags of organ preservation fluid, bags containing organs, and/or organs contained within the organ transportation apparatus 790. In some embodiments, the flanges 760 may have slots 765 that may enable easy removal of the upper receptacle 700 from an organ transportation apparatus 790. The slots 765 may be sized and shaped such that they could be used as handles for organ transportation personnel to grab and lift the upper receptacle 700.

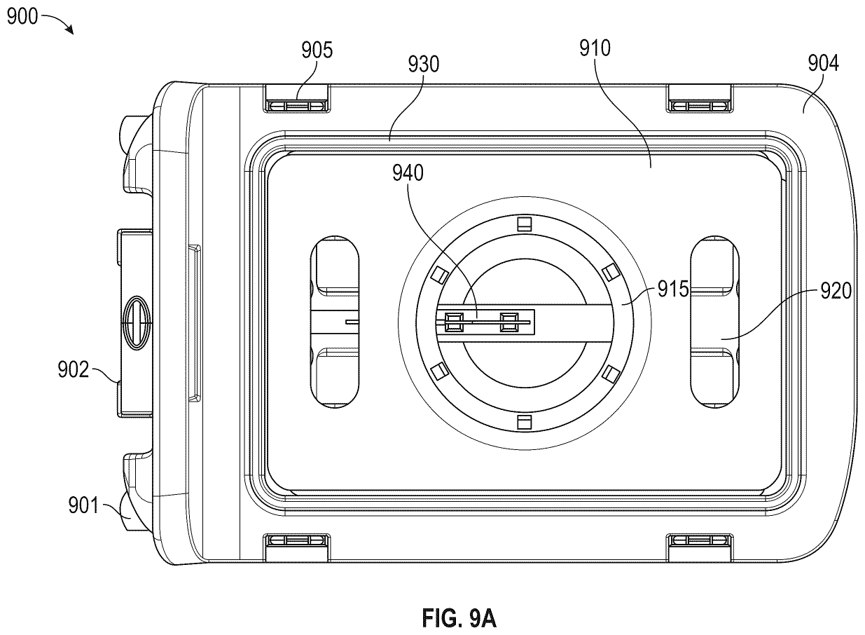

As previously mentioned, organs contained within these receptacles may be kept cool by at least one cooling pack. These cooling packs may be housed in the lid of the compartment, as seen, for example, in FIG. 8. FIG. 8 illustrates an exemplary compartment lid 800 with a retainer 810 for holding at least one cooling pack. The lid 800 may be configured to enclose the compartment. The lid 800 may be fully removable from the compartment. The retainer 810 may be a tray removably attached to the lid 800 (e.g., by screws, bolts, etc.) configured to house at least one cooling pack (e.g., four cooling packs). The retainer 810 may have slots 811 to enable airflow. The retainer 810 may be configured to protrude from the lid 800 and into the compartment. The retainer 810 may protrude just far enough into the compartment as to be right above the upper receptacle and hold the upper receptacle in place.

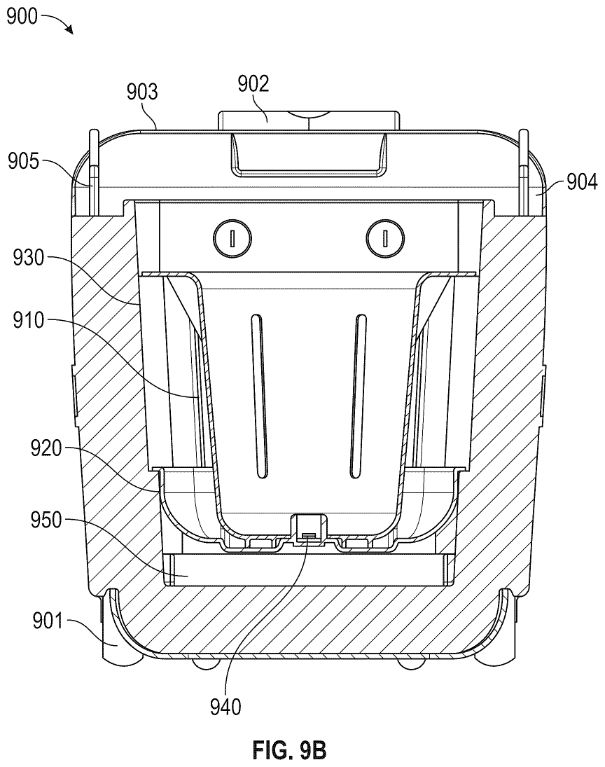

The at least one cooling pack may cool the inside of the compartment to a particular temperature, a temperature which may be monitored by a temperature probe as seen, for example, in FIGS. 9A and 9B. FIGS. 9A and 9B illustrate two views of an exemplary organ transportation apparatus 900 showing where the temperature sensor 940 may be connected. The temperature sensor 940 may be configured to attach to the lower receptacle 920 and rest within an aperture 915 of the upper receptacle 910 when both the upper receptacle 910 and lower receptacle 920 are within the compartment 930 of the organ transportation apparatus.

The temperature sensor 940 may be attached to a monitoring unit. In some examples, the monitoring unit stores temperature readings for later retrieval. For example, a user device, such as a smartphone, tablet, laptop, and/or other electronic device, running an application configured to interface with the monitoring unit, can connect to the monitoring unit via a wired or wireless connection. The user device and application can then be used to view and/or download temperature readings and/or any other parameter values stored by the monitoring unit, to verify that the organ remained within a desired range of temperatures during transport. Data downloaded from the monitoring unit to the user device via the application can be uploaded to a server (e.g., a cloud server) for long-term storage and/or access by other personnel. Optionally, the application running on the user device can be used to control one or more functions of the monitoring unit, such as to start and/or stop sensor reading logging, change a frequency of logging, set alarm limits, set calibration parameters, etc. For example, a member of an organ retrieval team may use an application running on a mobile device to initiate temperature logging, such as when the organ transportation apparatus 900 has been loaded with organ preservation solution and/or cooling packs 950 for transportation to a donor site and/or once an organ has been loaded into the organ transportation apparatus 900. In some examples, the monitoring unit can provide an alarm or other indication to a user when an optionally user-defined threshold temperature is reached within the organ transportation apparatus 900. Additionally or alternatively, an application running on a user's electronic device (e.g., smartphone) may receive temperature updates from the monitoring unit and may provide alerts based on the temperature updates, such as an alarm (e.g., visual, audible, and/or haptic) when the temperature exceeds an optionally user-defined threshold value. Optionally, the one or more temperature sensors 940 may be non-electronic sensors that a user may observe to determine a threshold temperature has been reached in the organ transportation apparatus 900. For example, one or more sensors may include color-changing chemical compositions that change colors at defined temperatures, and a user may open the organ transportation apparatus 900 and observe the color(s) of the sensor(s) to determine the temperature reached within the organ transportation apparatus 900.

Optionally, a user's portable computing device, such as a smartphone running a suitable application, can be connected (e.g., wirelessly) to the monitoring unit over a period of time and can monitor sensor readings from the monitoring unit over the period of time. For example, where a member of an organ retrieval team maintains custody of the organ transportation apparatus 900 during transportation, the user's mobile device can be continuously connected to the monitoring unit (e.g., via a Bluetooth connection or other suitable connection) and can continuously receive temperature readings. The application running on the mobile device may analyze the temperature readings, such as for providing an over-temperature warning and/or may upload the readings to a server (e.g., cloud server) for monitoring by remote personnel. The application running on the mobile device may upload location data to a server that may enable remote personnel to monitor the progress of the organ transportation. Thus, a remote user may be able to monitor the location and internal temperature of the organ transportation apparatus 900 (such as via an application or website). Optionally, the organ transportation apparatus 900 has a location tracking apparatus that can transmit location information to, for example, a server for retrieval by remote personnel.

The one or more monitoring units can monitor other parameters, such as location (e.g., by including or being operatively connected to a GPS receiver), time in use, motion (e.g., by including an internal measurement unit to monitor whether the organ transportation apparatus 900 has been knocked over and/or fallen), external temperature, lid opening occurrences, and/or any other parameters associated with use of the organ transportation apparatus 900.

Apart from the monitor, the organ transportation apparatus 900 also may comprise a number of features for ease of use and transportation. The organ transportation apparatus 900 may include one or more wheels 901 to facilitate transport of the organ transportation apparatus 900. The organ transportation apparatus 900 may include one or more handles 902 (e.g., a telescopic handle or foldaway handle) for pulling the organ transportation apparatus 900 when wheeled and/or for facilitating lifting of the organ transportation apparatus 900. The organ transportation apparatus 900 may include a lid 903. The lid 903 may be hingedly attached to the housing 904 or may be completely removable from the housing 904. The lid 903 may include one or more latches 905 for latching the lid 903 to the housing 904. One or more latches 905 may be keyed to prevent unauthorized access to an organ contained within the organ transportation apparatus 900.

The lid 903 may hold one or more cooling packs 950. For example, the retainer may be part of or may assemble to the lid 903 for holding one or more cooling packs 950. The lid 903 or any other component of the organ transportation apparatus 900 may include a document pouch for holding documents that may pertain to an organ being transported in the organ transportation apparatus 900.

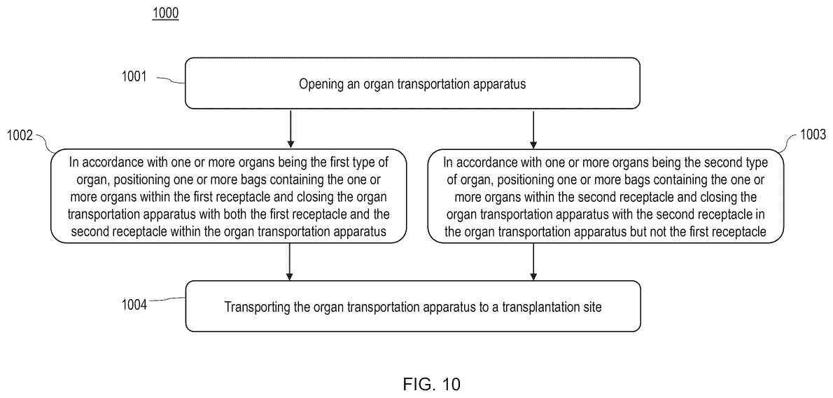

The organ transportation apparatus described in any of the embodiments above may be used in a method of organ transportation as shown, for example, in FIG. 10. FIG. 10 is a diagrammatic illustration of a method 1000 for transporting an organ for transplant, according to an aspect of the present disclosure.

At step 1001, an organ transportation apparatus may be opened, such as by opening a lid of the organ transportation apparatus. Step 1001 may be performed by one or more medical personnel at an organ donor site. The organ transportation apparatus may include at least one cooling pack, a first receptacle configured to hold at least a first organ type, and a second receptacle configured to hold at least a second organ type. In some embodiments, the first receptacle and the second receptacle may be in a nested configuration such that both receptacles fit within the apparatus.

In some embodiments, prior to, during, or after step 1001, the organ may be prepared and bagged. Bagging the one or more donor organs may include placing an organ preservation solution in the at least one bag. Bagging the one or more donor organs may include bagging the one or more donor organs in a plurality of bags, wherein an inner bag of the plurality of bags comprises the organ preservation solution. In some embodiments, after bagging the one or more donor organs, the bag may be sealed.

The organ preservation solution may have been stored in one or more bags in the organ transportation apparatus and retrieved from the organ transportation apparatus after the organ transportation apparatus was opened at step 1001. The organ transportation apparatus, loaded with the organ preservation solution, may have been prepared off-site and transported to the organ donor site. For example, at an off-site facility, the organ preservation solution may have been from a refrigerator and placed into the organ transportation apparatus.

As such, method 1000 may include, prior to step 1001, transporting the organ transportation apparatus from a first site (e.g., a site where organ transportation apparatuses are stored and/or prepared) to a second site where the organ donor may be located (e.g., a donor site) and removing an organ preservation solution from the organ transportation apparatus at the second site. One or more medical personnel that perform step 1001 (e.g., one or more members of an organ transplantation and/or transportation team) may transport the organ transportation apparatus to the second site or different personnel may transport the organ transportation apparatus to the second stie.

Method 1000 may include flushing the one or more donor organs (e.g., by a member of an organ transplant team) with organ preservation solution retrieved from the organ transportation apparatus. The method may include flushing the one or more donor organs with the organ preservation solution prior to removing the one or more donor organs from the organ donor and/or after removing the one or more donor organs from the organ donor.

The organ transportation apparatus may include at least one cooling pack that may have been pre-loaded into the organ transportation apparatus (e.g., pre-loaded at an off-site location). Alternatively, one or more cooling packs may be loaded into the organ transportation apparatus at the donor site after step 1001. The at least one cooling pack may be configured to maintain the temperature of a donor organ at 8 to 12 degrees C. within the organ transportation apparatus during storage and/or transportation of the one or more donor organs. In some embodiments, the organ transportation apparatus has multiple cooling packs. The cooling packs may be pre-cooled (e.g., refrigerated prior to transportation).

At step 1002, in accordance with the organ being a first type of organ, a bag containing the organ (along with preservation solution) may be positioned within a first receptacle sized for the first type of organ. The first receptacle may be positioned within the organ transportation apparatus when the organ is placed in the first receptacle. Alternatively, the first receptacle may have been removed from the organ transportation apparatus, and the organ may be placed in the first receptacle while the first receptable is outside of the organ transportation apparatus. The first receptacle may have been removed from the organ transportation apparatus to enable a user (e.g., a member of an organ transplant team) to access one or more bags of preservation solution stored within the organ transportation apparatus.

The organ transportation apparatus may include a second receptacle sized for a second type of organ. The first and second receptacles may have both been positioned within the organ transportation apparatus prior to step 1001. The second receptacle may remain in the organ transportation apparatus with the first receptacle and the organ held within the first receptacle. For example, the first receptacle may be nested with the first receptacle, according to the principles described above.

Step 1002 may include closing the organ transportation apparatus with both the first receptacle and the second receptacle within the organ transportation apparatus. In some embodiments, the first receptacle may be an upper receptacle and the second receptacle may be a lower receptacle. The first receptacle may be configured to be suspended within the organ transportation apparatus and stabilized by the second receptacle. In some embodiments, the one or more donor organs may be housed in the first receptacle and additional organ preservation fluid bags may be housed in the second receptacle. These may be housed around the first receptacle. In some embodiments, the first type of organ may be a heart.

Alternatively to step 1002, at step 1003, in accordance with the organ being a second type of organ, the bag containing the organ may be positioned within the second receptacle, with the second receptacle being configured to accommodating the second type of organ where, for example, the first receptacle does not. The first receptacle may be removed from the organ transportation apparatus prior to placing the organ within the second receptacle. The first receptacle may remain out of the organ transportation apparatus. The organ transportation apparatus may be closed with the second receptacle in the organ transportation apparatus but not the first receptacle.

In some embodiments, the first receptacle may be an upper receptacle and the second receptacle may be a lower receptacle. The first receptacle and the second receptacle may be configured to be removable. In some embodiments, the first receptacle may be above the second receptacle in the apparatus and may be removed first from the apparatus to reveal the second receptacle beneath it. In some embodiments, the first receptacle may be removed from the apparatus after opening such that the one or more donor organs can be positioned in the second receptacle. In some embodiments, additional organ preservation fluid bags may be housed in the apparatus at the same time the one or more donor organs may be within the apparatus. In some embodiments, the first type of organ may be one or more lungs, for example a left lung and/or a right lung. In some embodiments, the first type of organ may be one or more portions of a lung, for example one or more lobes of a lung that may be used in a lobular lung transplant.

At step 1004, the organ transportation apparatus, with the organ held within, may be transported to a donation site where an organ recipient is located. The organ transportation apparatus may be transported directly to the donation site or may be temporarily stored at one or more locations, such as an organ storage facility. In some embodiments, the organ may undergo one or more perfusion treatments while at a temporary storage site prior to being transported to the donation site. In some embodiments, one or more cooling blocks of the organ transportation apparatus may be replaced, such as at a temporary storage facility and/or during transportation, to maintain the organ within a desired temperature range.

In some embodiments, the organ transportation apparatus may be configured to maintain the apparatus at a predetermined, cooled temperature during transportation and/or storage. This temperature may be, for example, 8 to 12 degrees C. The temperature that the apparatus may be maintained at may be dependent on the temperature to which the cooling packs are cooled. The method may include, after storing and/or transporting the one or more donor organs in the organ transportation apparatus, removing the one or more donor organs from the organ transportation apparatus, and transplanting the one or more donor organs into the organ recipient. The one or more donor organs may be stored within the organ transportation apparatus for at least 1 hour. In some embodiments, the organ transportation apparatus does not contain any ice at any time during transportation and/or storage of the one or more donor organs and may instead rely on at least one cooling pack.

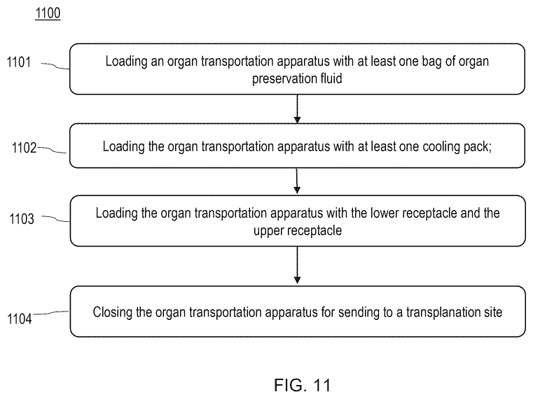

The organ transportation apparatus described in any of the embodiments above may be used in another method of organ transportation as shown, for example, in FIG. 11. FIG. 11 is a diagrammatic illustration of a method 1100 for organ transportation, according to an aspect of the present disclosure.

At step 1101, an organ transportation apparatus may be loaded with at least one bag of organ preservation fluid. The apparatus may comprise an insulating enclosure comprising a compartment, a lower receptacle positionable in the compartment configured to hold at least a first type of organ, and an upper receptacle positionable in the compartment above the at least one lower receptacle and configured to hold at least a second type of organ. The at least one bag of organ preservation fluid may be additional organ preservation fluid that may be used to flush a donor organ. The at least one bag of organ preservation fluid may be stored above the lower receptacle and around the upper receptacle in the compartment. The at least one bag of organ preservation fluid may, additionally or alternatively, be stored within the upper receptacle or lower receptacle. The at least one bag of organ preservation fluid may be loaded after the lower receptacle but before the upper receptacle. Additionally or alternatively, the at least one bag of organ preservation fluid may be loaded after the upper receptacle. The at least one bag of organ preservation fluid may be the third and/or fourth component loaded into the apparatus.

At step 1102, the organ transportation apparatus may be loaded with at least one cooling pack. The cooling packs may be pre-cooled to a pre-determined temperature (e.g., by refrigeration). The cooling packs may be loaded into the bottom of the compartment of the organ transportation apparatus in a space below where the lower receptacle may sit. These cooling packs may be the first component loaded into the organ transportation apparatus. The cooling packs may also be loaded into the retainer of a lid of the compartment of the organ transportation apparatus. These cooling packs may be the last component loaded into the organ transportation apparatus prior to closing the apparatus. More than one cooling pack may be loaded into each location within the apparatus accommodating one or more cooling packs.

At step 1103, the organ transportation apparatus may be loaded with the upper receptacle and the lower receptacle. Step 1103 may be performed along with steps 1101 and/or 1102 (i.e., they may be performed in parallel, not serially). For example, one or more of the receptacles may be positioned in the organ transportation apparatus prior to loading the preservation fluid in the organ transportation apparatus and/or prior to loading one or more cooling packs in the organ transportation apparatus.

In some embodiments, both the upper receptacle and the lower receptacle may be positioned within the compartment. In some embodiments, the upper receptacle may be positioned above the lower receptacle such that the upper receptacle may be stabilized by the lower receptacle. In some embodiments, the lower receptacle may be loaded into the apparatus after the first set of cooling packs. In some embodiments, the lower receptacle may be the second component loaded into the apparatus. In some embodiments, the upper receptacle may be loaded into the apparatus after the lower apparatus. In some embodiments, the upper receptacle may be the third and/or fourth component loaded into the apparatus. The compartment may facilitate organ transportation because multiple organ receptacles may be transported and cooled within a single apparatus and a user may select which receptacle may be suitable for the one or more donor organs(s) that will be transported.

In some embodiments, a temperature sensor may be attached to the lower receptacle and communicatively coupled to a monitoring unit. The temperature sensor may be a removable temperature probe. This may enable tracking of temperature and/or other useful parameters within the organ transportation apparatus during transport.

At step 1104, the organ transportation apparatus may be closed for sending to a transplantation site. In some embodiments, the lid of the compartment may be latched close.

The foregoing description, for the purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the techniques and their practical applications. Others skilled in the art are thereby enabled to best utilize the techniques and various embodiments with various modifications as are suited to the particular use contemplated.

Although the disclosure and examples have been fully described with reference to the accompanying figures, it is to be noted that various changes and modifications will become apparent to those skilled in the art. Such changes and modifications are to be understood as being included within the scope of the disclosure and examples as defined by the claims. Finally, the entire disclosure of the patents and publications referred to in this application are hereby incorporated herein by reference.

1. An organ transportation apparatus comprising:
an insulating enclosure comprising a compartment;
a lower receptacle positionable in the compartment configured to hold at least a first type of organ; and
an upper receptacle positionable in the compartment above the lower receptacle and configured to hold at least a second type of organ.

2. The organ transportation apparatus of claim 1, wherein the compartment comprises at least one shelf configured to support the upper receptacle, and the upper receptacle comprises at least one flange configured to be positioned on the at least one shelf.

3. The organ transportation apparatus of claim 1, wherein the compartment comprises at least one shelf configured to support the lower receptacle.

4. The organ transportation apparatus of claim 1, wherein the at least one first type of organ comprises a lung and the at least one second type of organ comprises a heart.

5. The organ transportation apparatus of claim 1, further comprising a temperature sensor attached to the lower receptacle.

6. The organ transportation apparatus of claim 1, wherein the lower receptacle and the upper receptacle comprise openings that enable airflow.

7. The organ transportation apparatus of claim 6, wherein the lower receptacle comprises at least one recess for receiving at least one projection of the upper receptacle for providing stability to the upper receptacle.

8. The organ transportation apparatus of claim 1, wherein the upper receptacle and the lower receptacle are removable.

9. The organ transportation apparatus of claim 1, wherein the upper receptacle comprises at least one wall defining a chamber for supporting the second type of organ, the chamber sized to accommodate an entire second type of organ.

10. The organ transportation apparatus of claim 9, wherein the lower receptacle comprises at least one wall defining a chamber that is sized to only partially accommodate the first type of organ within.

11. The organ transportation apparatus of claim 9, wherein the at least one wall of the upper receptacle is spaced from a side wall of the compartment to accommodate one or more bags of organ preservation fluid.

12. The organ transportation apparatus of claim 1, further comprising at least one cooling pack positioned within the compartment below the lower receptacle.

13. The organ transportation apparatus of claim 12, wherein a side wall of the compartment has at least one shelf and the lower receptacle is positioned on the at least one shelf such that the lower receptacle is spaced apart from the at least one cooling pack.

14. The organ transportation apparatus of claim 1, further comprising at least one cooling pack positioned above the upper receptacle.

15. The organ transportation apparatus of claim 14, wherein a lid of the apparatus comprises a retainer configured to hold the at least one cooling pack positioned above the upper receptacle.

16. The organ transportation apparatus of claim 15, wherein the retainer is configured to hold the upper receptacle in place.

17. A method for transporting one or more organs for transplant, the method comprising:
opening an organ transportation apparatus, the apparatus comprising:
at least one cooling pack,
a first receptacle configured to hold at least a first organ type, and
a second receptacle configured to hold at least a second organ type;
in accordance with the one or more organs being the first type of organ, positioning one or more bags containing the one or more organs within the first receptacle and closing the organ transportation apparatus with both the first receptacle and the second receptacle within the organ transportation apparatus;
in accordance with the one or more organs being the second type of organ, positioning one or more bags containing the one or more organs within the second receptacle and closing the organ transportation apparatus with the second receptacle in the organ transportation apparatus but not the first receptacle; and
transporting the organ transportation apparatus to a transplantation site.

18. The method of claim 17, wherein the organ transportation apparatus is configured to maintain the one or more organs at a temperature of 8 to 12 degrees C. during storage.

19. The method of claim 17, further comprising removing at least one bag containing organ preservation fluid from the compartment.

20. The method of claim 19, further comprising using at least a portion of the organ preservation fluid in the at least one bag containing organ preservation fluid to flush at least one of the one or more organs.

21. The method of claim 19, further comprising placing the one or more organs in at least one bag containing organ preservation fluid and sealing the bag.

22. The method of claim 17, further comprising perfusing at least one of the one or more organs with an organ perfusion solution.

23. A method for organ transportation, the method comprising:
loading an organ transportation apparatus with at least one bag of organ preservation fluid, the apparatus comprising:
an insulating enclosure comprising a compartment;
a lower receptacle positionable in the compartment configured to hold at least a first type of organ; and
an upper receptacle positionable in the compartment above the at least one lower receptacle and configured to hold at least a second type of organ;
loading the organ transportation apparatus with at least one cooling pack;
loading the organ transportation apparatus with the lower receptacle and the upper receptacle; and
closing the organ transportation apparatus for sending to a transplantation site.

24. The method of claim 23, further comprising storing the at least one bag of organ preservation fluid, the at least one cooling pack, or both, at 2-6 C prior to loading into the organ transportation apparatus.

25. The method of claim 23, wherein the at least one cooling pack is loaded into a bottom portion of the compartment.

26. The method of claim 23, wherein the at least one cooling pack is loaded into a lid of the compartment.

27. The method of claim 23, further comprising attaching a temperature monitor to the lower receptacle, wherein the temperature monitor comprises a removable temperature probe.

28. The method of claim 23, wherein loading with the at least one bag of organ preservation fluid, loading the at least one cooling pack, and loading the lower receptacle and the upper receptacle comprises:
first, loading at least one of the at least one cooling packs;
second, loading the lower receptacle;
third, loading the at least one bag of organ preservation fluid;
fourth, loading the upper receptacle; and
fifth, loading at least one of the at least one cooling packs.
